(19) United States
(12) Patent Application Publication
(10) Pub. No.: US 2011/0009191 A1
(43) Pub. Date: Jan. 13, 2011

(54) SYSTEM AND METHOD FOR MULTI-MEDIA GAME

(76) Inventor: Eugeny Naidenov, Kaliningrad (RU)

Correspondence Address: DERGOSITS & NOAH LLP, Three Embarcadero Center, Suite 410, SAN FRANCISCO, CA, 94111, US

(21) Appl. No.: 12/832,825

(22) Filed: Jul. 8, 2010

Related U.S. Application Data
(60) Provisional application No. 61/223,996, filed on Jul. 8, 2009.

(51) Int. Cl. A63F 13/00; A63F 9/24

(52) U.S. Cl. 463/35; 463/43

(57) ABSTRACT

This disclosure describes a system and method for providing a computer-based rhythm game using game data supplied by one or more users that is synchronized to audio data of musical performances stored on a user's personal computing device. A user access a server storing game data, selects a game data file, and downloads the game data file to his computer. A rhythm game application plays a music file on the computer, and synchronizes the game data file with the music file to create an integrated rhythm game.

### CROSS-REFERENCE TO RELATED APPLICATIONS

This application is a nonprovisional patent application of U.S. Patent App. No. 61/223,996, entitled “SYSTEM AND METHOD FOR MULTI-MEDIA GAME,” filed on Jul. 8, 2009 and incorporated in full herein.

### FIELD

This disclosure relates generally to rhythm-based computer games, and specifically, to multi-platform rhythm-based computer games that can be customized by one or more users.

### BACKGROUND

Rhythm-based computer games (also known as music video games, music games or rhythm games) are games in which a user or player attempts to match a song's rhythm using keystrokes from a keypad, game controller or other peripheral device. The song's rhythm is synchronized to graphics such as a colored indicators traveling toward the user along a guitar fret board or “note highway.” The colored indicators correspond to various keys or keystrokes on the game controller. In order to gain points and advance through the game, the user is supposed to coordinate the pressing of keys on the game controller with the displayed colored indicators. Keys must also be pressed to match the rhythm and time of the displayed colored indicators. The complexity and sequence of key pressing increases the longer the user plays the game. This type of game play is also known as “call and response.”

The rhythm game typically uses licensed, authorized musical performances from real-world music artists and music groups. In this manner, the user is provided with an interactive experience designed to simulate a performance with the music artists. In this fashion, the user feels like “part of the band,” or feels that they are performing an accurate rendition of the musical performance. To provide this experience, the game software will include licensed master recordings or re-recordings of the musical performance. In order to upgrade or expand a user's copy of the game to include new musical performances, the user will need to purchase or download expansion packs or other versions of the game.

Because the rhythm game relies on licensed, authorized musical performances, expansion packs and game upgrades are dependent upon the game producer's ability to procure the necessary licenses for the game. If a music artist prefers not to include her music in the rhythm game, then the rhythm game loses the opportunity to attract users who are also fans of that artist's music. If license negotiations become lengthy and protracted, the rhythm game producer may lose market momentum by the delay in bringing new upgrades and features to the marketplace. What is therefore needed is a way to produce rhythm games without requiring extensive music licenses or legal agreements.

A user will typically have varied musical tastes beyond what is available in any one copy or version of the rhythm game. In fact, the user may have a vast personal music library with musical performances from artist's or genres that are not included in any currently available versions of a rhythm game. It is impossible for today's rhythm game producer to capture every music fan, especially since market dynamics will typically force the rhythm game producer to include only pop music, rather than other less popular music genres that may still have a large number of fans. What is therefore needed is a rhythm game that allows a user to include any of the musical performances from his own music library, thereby providing enjoyment of rhythm games without being dependent on any one music genre.

It is not unusual for a user to have multiple storage locations for a music library. For example, a user may store music on a computer, on external storage, as well as on a mobile device such as a smartphone or mp3 music player. What is therefore needed is a way for the user to integrate the rhythm game experience regardless of platform.

A user may only like a few of the songs that may be included in a copy or version of the game. This may ultimately affect whether that user purchases the rhythm game, since the investment of the user's time and money may not be worth the expense of the game. What is therefore needed is a rhythm game that may be customized song by song, such that the user can pick which songs to incorporate in the game, thereby improving game play and promoting user enjoyment.

Rhythm games are usually an individual game such that a user plays as a single player, or if multiple player options are available, then each player must be located in the same physical location as the rhythm game being played. This limits the amount of social networking or community-building that can occur based on the game. What would be beneficial is a rhythm game that enables users to compete with one another regardless of location or platform, and/or that enables users to contribute to the improvement of the game, thereby building a community around the game and promoting social networking.

### BRIEF DESCRIPTION OF THE FIGURES

FIG. 1 is a block diagram depicting an embodiment.

FIG. 2 is a flow diagram of an embodiment.

FIG. 3 is a screenshot of an embodiment.

FIG. 4 is a screenshot of an embodiment.

FIG. 5 is a screenshot of an embodiment.

FIG. 6 is a screenshot of an embodiment.

FIG. 7 is a screenshot of an embodiment.

FIG. 8 is a flow diagram of an embodiment.

FIG. 9 is a screenshot of an embodiment.

FIG. 10 is a screenshot of an embodiment.

FIG. 11 is a screenshot of an embodiment.

FIG. 12 is a screenshot of an embodiment.

FIG. 13 is a screenshot of an embodiment.

### DETAILED DESCRIPTION

Disclosed herein is a system and method for creating a rhythm game capable of being played on a variety of computing platforms and capable of being customized by one or more users. As will be discussed further below, an embodiment of this disclosure is directed to a rhythm game that incorporates a user's personal music library, such that any musical performances stored on or accessed by the user's computing device may provide the audio content for the rhythm game. Game play is provided by one or more rhythm game data files that contain information on synchronizing game graphics and game play to the audio content of a particular musical performance. A user selects a rhythm game data file created specifically for a song in the user's music library, and when the user executes a rhythm game application installed on the user's computing device, the rhythm game data file will play synchronously with the audio content of the musical performance from the user's music library, thereby providing the full rhythm game experience.

As referred to herein, the audio content of a music file may be referred to as a song or audio musical performance. One of ordinary skill in the art will appreciate the music file may contain the song, as well as other information about the song, but that “music file” and “song” may be referred to interchangeably without limiting this disclosure to any embodiment.

It should be appreciated that an embodiment can be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

In the context of this document, a computer usable medium or computer readable medium may be any medium that can contain or store the program for use by or in connection with the instruction execution system, apparatus or device. For example, the computer readable storage medium or computer usable medium may be, but is not limited to, a random access memory (RAM), read-only memory (ROM), or a persistent store, such as a mass storage device, hard drives, CDROM, DVDROM, tape, erasable programmable read-only memory (EPROM or flash memory), or any magnetic, electromagnetic, infrared, optical, or electrical system, apparatus or device for storing information. Alternatively or additionally, the computer readable storage medium or computer usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory.

Applications, software programs or computer readable instructions may be referred to as components or modules. Applications may be hardwired or hard coded in hardware or take the form of software executing on a general purpose computer such that when the software is loaded into and/or executed by the computer, the computer becomes an apparatus for practicing an embodiment. Applications may also be downloaded in whole or in part through the use of a software development kit or toolkit that enables the creation and implementation of an embodiment. In this specification, these implementations, or any other form that an embodiment may take, may be referred to as techniques. In general, the order of the steps of disclosed processes may be altered within the scope of this disclosure.

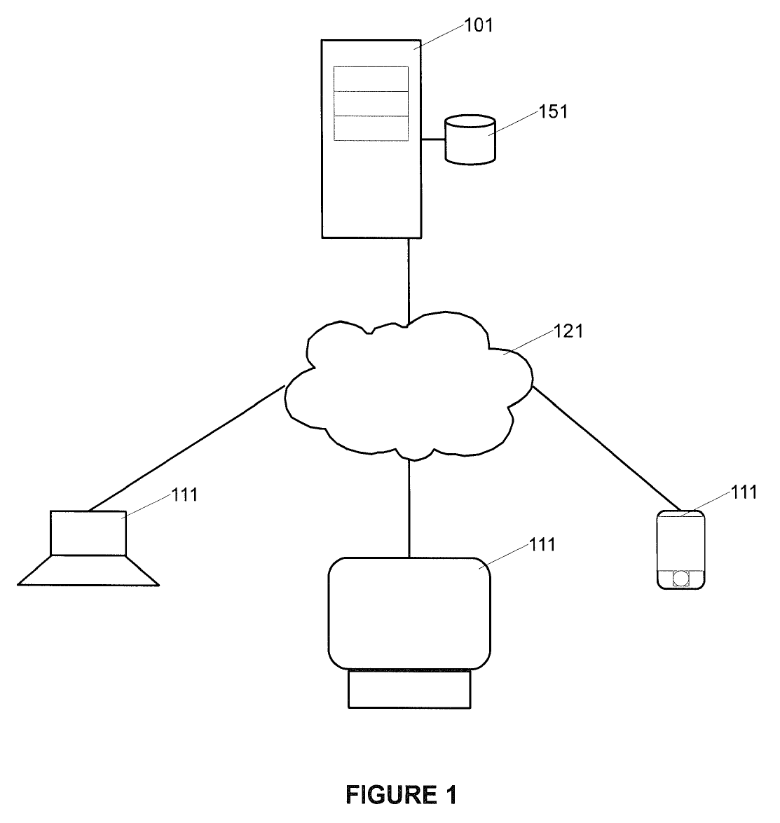

FIG. 1 is a block diagram illustrating a system for creating and providing a rhythm game, according to an embodiment of this disclosure. FIG. 1 includes a server 101. One having ordinary skill in the art will appreciate that even though one server is shown in FIG. 1, there may be more than one server accessible using network 121, and that reference to one server is not meant to be limiting in any fashion. Server 101 is associated with a memory store 151, which may reside within server 101 or may be accessible using network 121, includes one or more rhythm game data files. Rhythm game data files will be discussed in more detail below.

One more computing devices 111 have access to server 101 using network 121. Computing devices 111 include desktop computers, laptop computers, portable gaming devices, gaming consoles, handheld computers, netbooks, tablet computers, smartphones, cellular telephones, personal data assistants, mobile communication devices and any other device having memory and capable of running software applications of the type described herein. This disclosure is not limited to the use of any one type of computing device, and one having ordinary skill in the art will appreciate that other types of computing devices may perform embodiments of this disclosure.

In an embodiment, each of the one or more computing devices 111 will have access to or will store at least one music file containing an audio musical performance. For example, a user may store music files on his personal computer in the form of an Apple iTunes® or Windows Media® Player library. Alternatively or additionally, music files may be accessible on a dedicated network storage device, such as a Seagate FreeAgent® Theater™. For purposes of this disclosure, music files may be stored in any format and in any location accessible to a user and his computing device.

In an embodiment of this disclosure, a rhythm game application is installed on each of the computing devices 111. Alternatively or additionally, the rhythm game application may execute on server 101 and be accessible using a web browser; however, music files may remain in the user's music library, rather than being uploaded or transmitted to any other computing device or server. The rhythm game application will enable the synchronization of music files to remotely or locally stored rhythm game data files, thereby rendering the rhythm game experience. In an embodiment, the rhythm game application may provide a way to browse server 101 to search for and select rhythm game data files, to search for and select game upgrades, communicate with other game users, and the like. In an embodiment, the rhythm game application may search the music library on the resident computing device 111, and may store or access a database identifying the songs in the music library. The rhythm game application may transmit a listing of songs in the music library to server 101 for purposes of obtaining matching rhythm game data files. In an embodiment, the rhythm game application or a rhythm game editor application may provide a way for a user to create and/or edit game data files for upload to server 101 for access by other users.

In an embodiment, a rhythm game data file is a text file that includes information identifying the music file to which the data file corresponds, as well as information that provides the rhythm game play for the corresponding music file. Identifying information may include, but is not limited to, the title of the song contained in the music file, the name of the performer of the song, the song's album, a copyright or performance date for the song, and the like. Game play information may include, but is not limited to rhythm timing data for the song, information as to when certain graphics should appear, a proper sequence for key input entry, the level of difficulty for the song, information on how to increase the difficulty of game play for the song, the length of notes played during the song, etc. In this fashion, the rhythm game data file provides sufficient information such that a rhythm game application executing on the computing device 111 or on server 101 will be able to synchronize the data file with the proper music file, and provide the rhythm game play that the user sees and plays on his computing device 111.

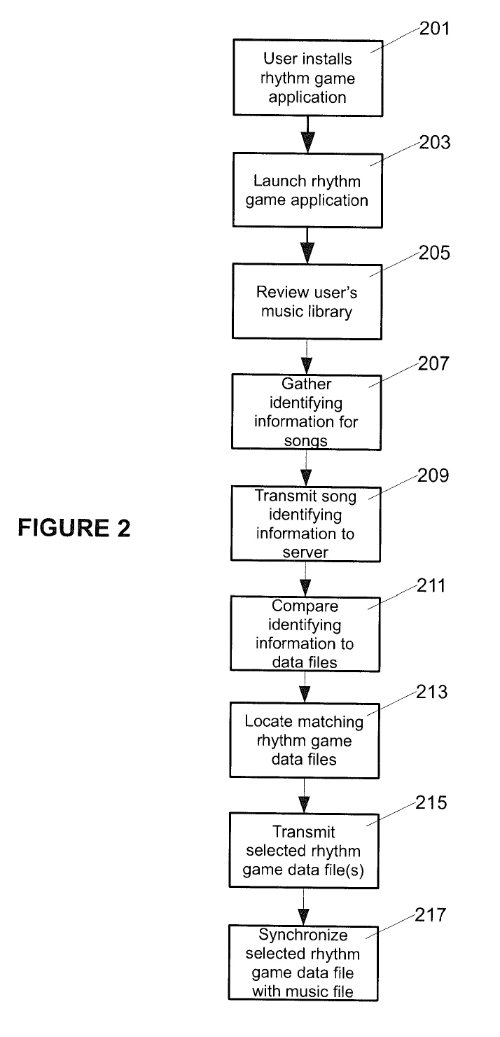

The following describes an embodiment in which a user installs and executes the rhythm game application on his computing device. FIG. 2 is a flow chart illustrating a method embodiment. In block 201 of FIG. 2, a user may download and install the rhythm game application on a computing device. The rhythm game application may be downloaded from a website (e.g., download.com), or from an application provider, (e.g., Apple App Store™ or Android Market™), or may be purchased from a retail store and installed from a computer usable medium. In an embodiment, a computing device that already has a copy of the rhythm game application may provide it to another computing device by wirelessly transmitting or using a wired transfer method. One having ordinary skill in the art will appreciate that there are many ways to obtain, share, and/or download the rhythm game application, and that the examples describes above are not meant to be limiting in any way.

In block 203 of FIG. 2, the user of the computing device may launch the installed rhythm game application. The first time the rhythm game application launches, it may review the user's music library (block 205) to gather identifying information for the songs in the user's music library (block 207). This identifying information may include song titles, performer names and/or album names. Alternatively or additionally, identifying information may include a unique identifier for the song (e.g., Gracenote MusicID®) or the rhythm game application may utilize music recognition technology to identify the songs in the music library (e.g., acoustic fingerprinting). Once identifying information for some or all of the songs is gathered by the rhythm game application, this information may be transmitted to server 101 (block 209). Server 101 receives the transmitted information, and compares the received information to a listing of rhythm game data files (block 211), which may be stored in memory store 151. The listing may include all the rhythm game data files that are available for users of the rhythm game application.

In block 213 of FIG. 2, if there is a match between the identifying information received from the user's device and the listing of rhythm game data files, then server 101 may locate the corresponding rhythm game data files for transmission to the computing device. Corresponding rhythm game data files are then transmitted to the computing device 111 for storage in the device's local memory (block 215). One having ordinary skill in the art will appreciate that the user may be presented with a list of the corresponding rhythm game data files that match songs in the user's music library, and the user may select one, some, or all of the game data files for transfer to his computing device. In block 217 of FIG. 2, when a user chooses which song to play during the rhythm game play, the rhythm game application will synchronize the chosen song with the corresponding rhythm game data file stored in the device's local memory or accessed by the computing device 111 on server 101.

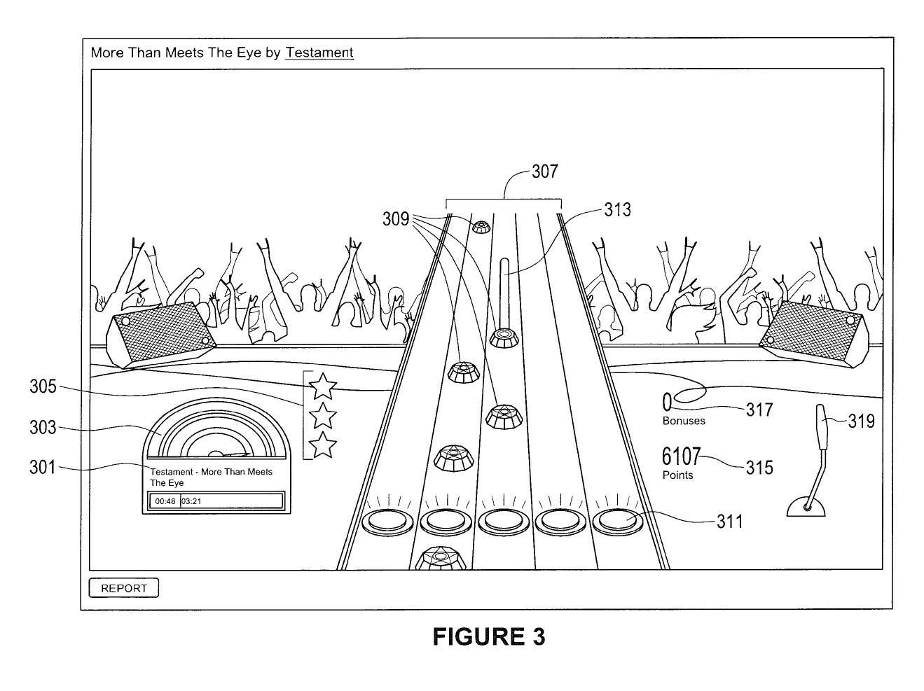

FIG. 3 is a screenshot of a rhythm game, according to an embodiment of this disclosure. A person of ordinary skill in the art will appreciate that the rhythm game shown in FIG. 3 and disclosed herein is merely an embodiment, and not intended to limit this disclosure to any specific depiction. One will also appreciate that the rhythm game play may be scaled to fit the display of the computing device that the user is operating. In FIG. 3, song information box 301 may provide information on the song being played. For example, as shown, the artist (“Testament”) and song title is displayed (“More Than Meets The Eye”). In addition, there may be a graphic showing the total length of the song forming part of song information box 301. As shown in FIG. 3, 48 seconds of a 3 minute, 21 second song has transpired. This may provide the player with information on the duration of the song and the user's progress. There may also be a “power meter” 303 or other measurement showing how accurate or precise a user is when playing the game.

One skilled in the art will appreciate that keystroke entry may differ depending upon the computing device. For example, computing devices with keyboards can incorporate keyboard keys, mouse buttons, joystick buttons, and the like. Gaming consoles can incorporate a controller or a specific peripheral (such as a guitar-like peripheral). Smartphones, mp3 players or other portable gaming devices having a touchscreen may respond to touchscreen or stylus interaction. The actual operation and interaction with the game may vary.

In an embodiment, a fret board 307 or other note highway may be used to indicate upcoming notes 309 as they approach indicators 311. As notes 309 travel toward the user, the user may enter keystrokes to correspond with the notes 309 before the notes 309 overlap indicators 311. Notes 309 may also indicate whether keystrokes should be quickly entered or sustained. For example, sustained notes may have a following line, or “tail” (313 in FIG. 3). One of ordinary skill in the art will appreciate that other patterns, symbols or colors may be used to represent different types of notes 309 corresponding to different game play. For example, during game play, one or more differently colored notes 309 may represent “superpower” or “bonus” notes that a user may earn or activate by correctly entering a keystroke or sequence of keystrokes. Stars 305 may represent how many of these special superpower notes have been earned. In an embodiment, after earning a certain number of stars 305, the user may activate a “superpower” mode of game play, which may lead to a greater and/or faster accrual of points, access to different features of game play, and the like. Other specialized modes or bonus rounds may also be available to a user, and this example is not intended to limit this disclosure.

Indicators 311 of FIG. 3 represent the keystrokes that the user should input during game play. In FIG. 3, five indicators are shown; however, one of ordinary skill in the art will appreciate that three indicators may be shown for “easier” games, and five indicators may be reserved for more “difficult” levels of game play. Multiple keystrokes representing chords may also be represented by indicators 311. The number, color and size of the indicators 311 may vary without departing from this disclosure, and FIG. 3 is not intended to be limiting in any fashion.

Besides indicators 311, a whammy bar 319; may be used to enhance game play. For example, a keystroke corresponding to whammy bar 3193 may be entered in order to sustain notes, alter pitch, or activate other game play features.

As a user correctly enters in the proper sequence of keystrokes, the user may gain points that are displayed in scorebox 315. There may also be opportunities for the user to earn bonus points, which will accrue in bonus box 317. Game play may continue when a user successfully completes a song performance, an album performance, reaches a certain game level, and the like. One will appreciate that there are many ways to conclude a rhythm game without departing from this disclosure.

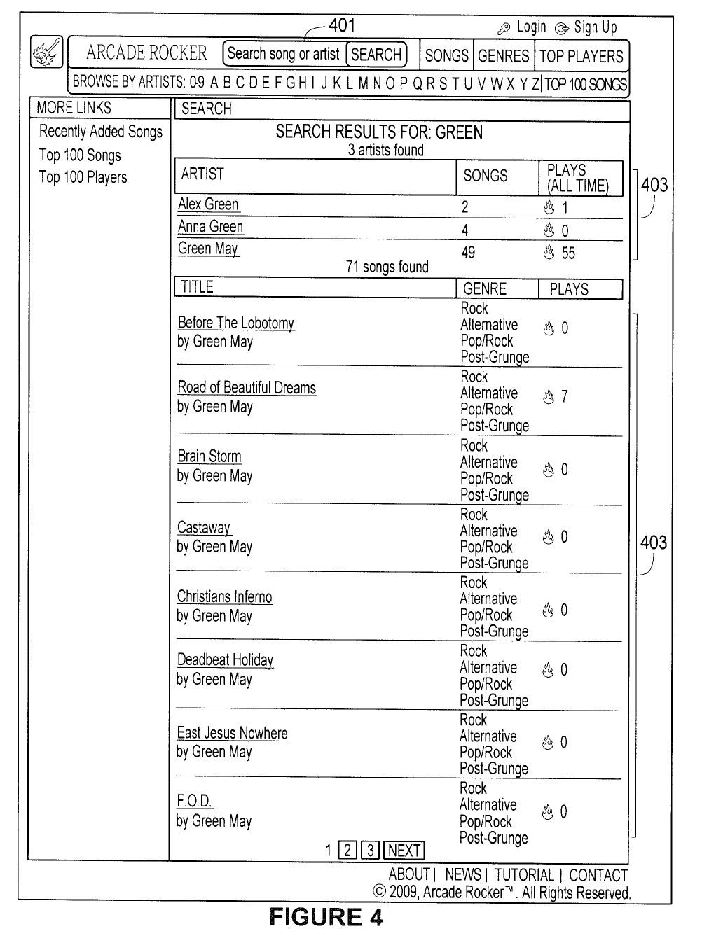

One of ordinary skill in the art will appreciate that there may be many ways to locate rhythm game data files to match music files in a user's music library. In an embodiment, a user can browse or search an online database of rhythm game data files. FIG. 4 is a screenshot of a searchable database whereby a user can locate rhythm game data files by entering a keyword in search box 401. The database will return any result containing the keyword, such as the name of a performer, band, and/or artist containing the keyword (403) or the titles of songs containing the keyword (405).

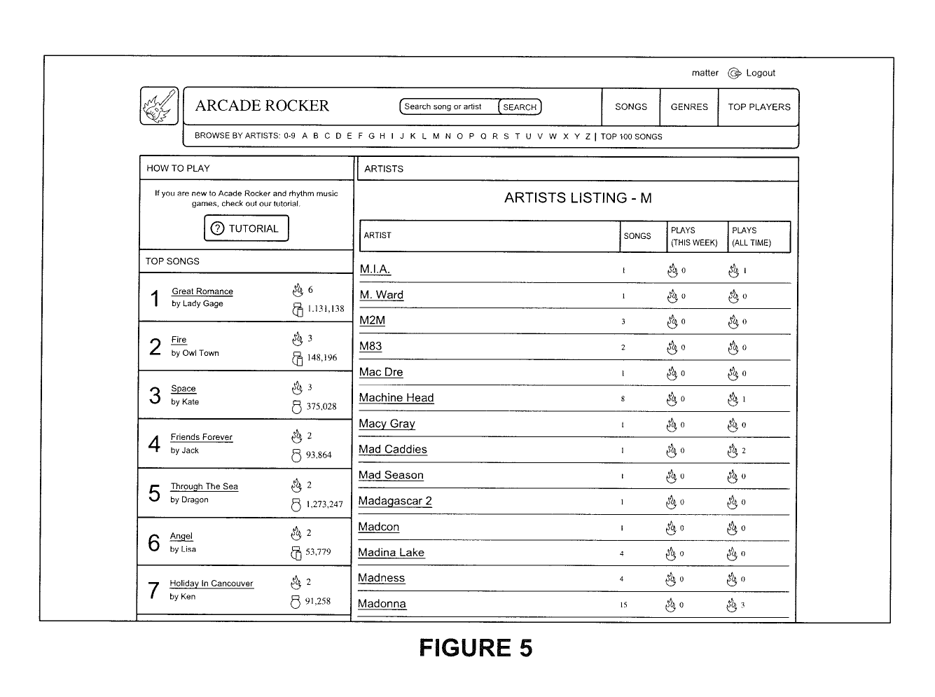

Alternatively of additionally, a user may browse a database of artist names, such as the embodiment shown in FIG. 5. As FIG. 5 illustrates, the user can select any artist whose name begins with the letter “M.” Selecting any of the artist names may lead to another screen showing album titles or specific song titles that correspond to downloadable rhythm game data files.

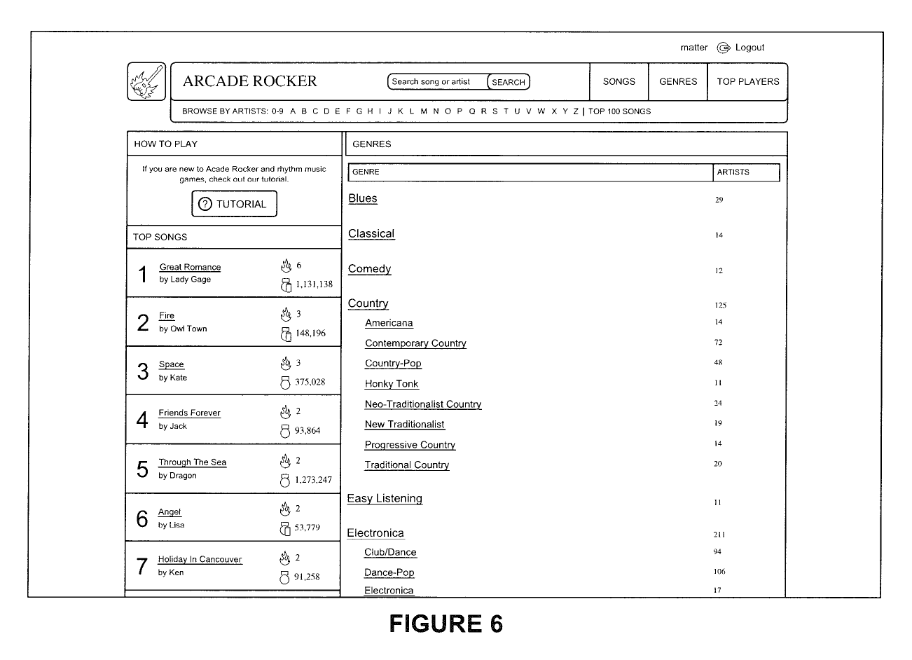

Alternatively or additionally, a user may browse a database of music genres, such as the embodiment shown in FIG. 6. One will appreciate that there are any number of ways to search an online database of available rhythm game data files, and that FIGS. 4, 5 and 6 are not meant to limit this disclosure to any one method for locating rhythm game data files.

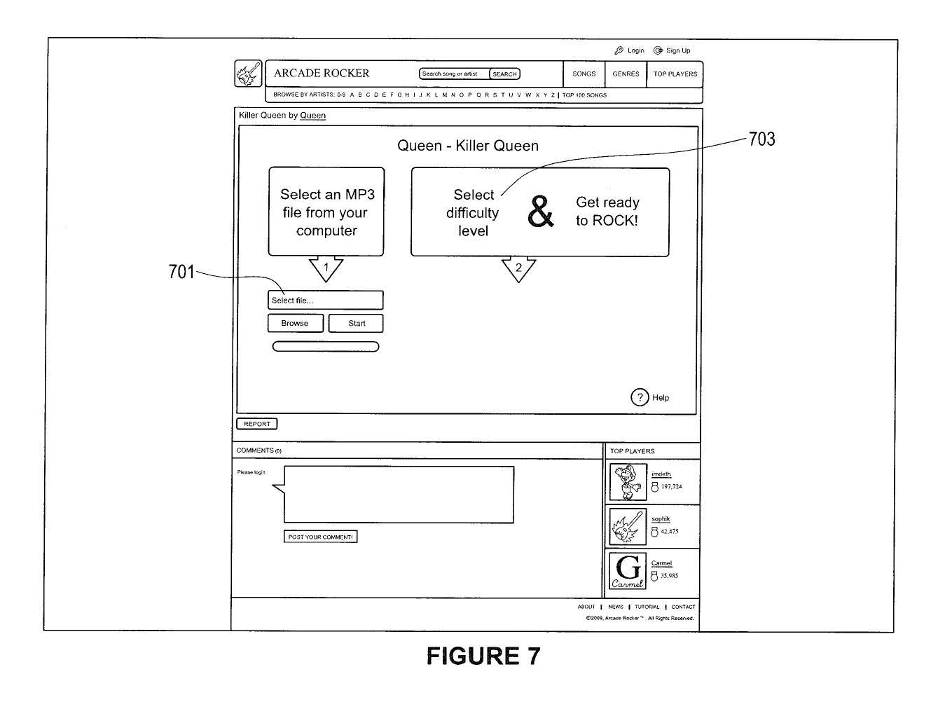

Once a user locates a desired rhythm game data file, the user may be presented with a screen similar to that shown in FIG. 7. This screen may serve as the presentation prior to actual game play. As shown, in box 701, the user can locate the music file in his music library that will be synchronized to a corresponding rhythm game data file. In box 703, the user may have the option to select the level of difficulty of play. Other options may also be presented to the user.

One will appreciate that in the above examples, the rhythm game application may be locally installed on the user's computing device 111, and the rhythm game application may provide the interface for browsing online databases of rhythm game data files. In an embodiment, the rhythm game application may be hosted on a web server, and the user may use a web browser to select the rhythm game data file that corresponds to a music file on in the user's music library. After selection, the user may be presented with a screen similar to FIG. 7, and the online rhythm game application will be able to synchronize the selected music file from the user's library with the corresponding rhythm data file stored online.

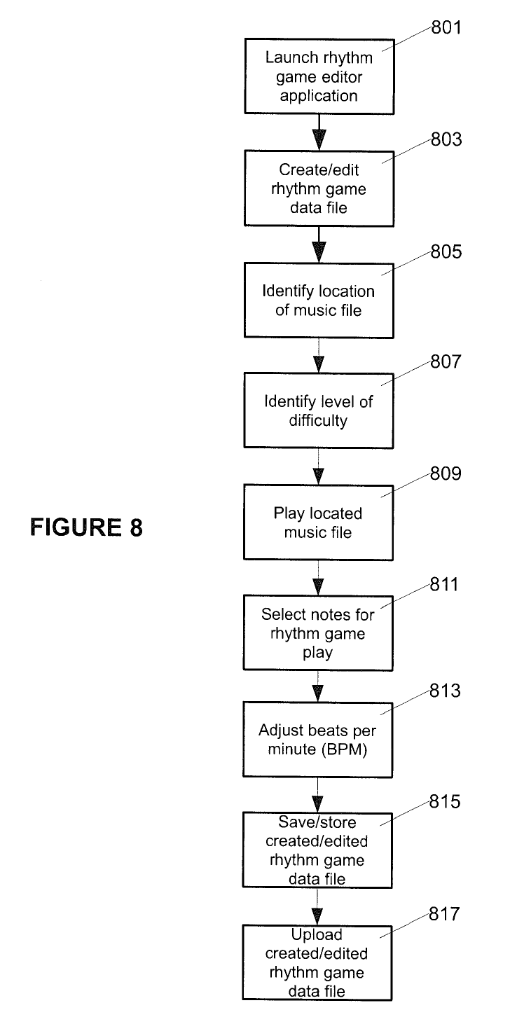

In an embodiment, a user may create rhythm game data files using a song from his personal music library. FIG. 8 is a flow diagram depicting an embodiment in which a rhythm game data file editor application may be used to create or edit rhythm game data files. In block 801 of FIG. 8, a user launches the editor application, which may be part of or separate from the rhythm game application. In block 803 of FIG. 8, the user may have the option of creating a new rhythm game data file or editing an existing rhythm game data file. In block 805, the user identifies the location of the music file, which may be in any known audio file format, such as MP3. In block 807, the user may also specify the difficulty level for the game play. One will appreciate that the user may have change the difficulty level from the initial selection in block 807.

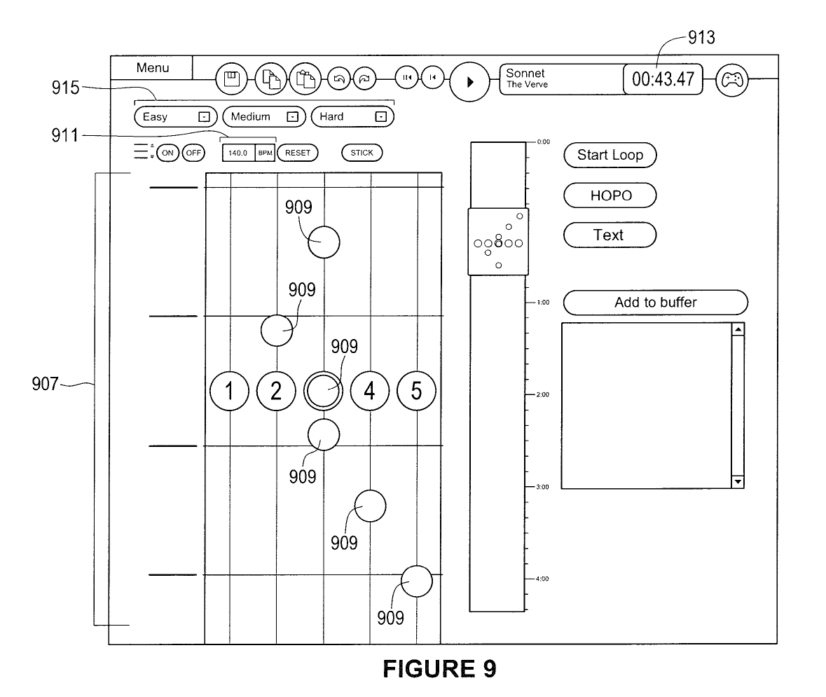

To ensure that during game play, notes 309 and indicators 311 synchronize properly and for the appropriate duration, the user may play the selected music file (block 809). Note selector buttons numbered one (1) through (5) may be selected during the playing of the music file, and a corresponding note may be placed on an appropriate location for display on a fret board (block 811) or note highway. A screenshot of the editor application appears in FIG. 9. As shown in FIG. 9, the user may select which portion of the fret board 907 to identify when a note 909 should be played. One will appreciate that notes 909 may be moved and dragged to a new location, if necessary. Identifying notes 909 may involve using a mouse or touchscreen or other input device. One of ordinary skill in the art will appreciate that when a note is placed, another note can be placed at the distance not shorter than the “note length” (e.g. the duration of a note). Other options may exist for adding and identifying notes 909 in the editor application. For example, if a note is selected for display (block 811 of FIG. 8), but is depressed or selected for a certain time duration, that time duration may correspond to the length of time the corresponding keystroke should be entered during game play. Time duration may also be added or edited using a time duration indicator. For example, sustained notes during game play may be followed by a line or “tail.” In the editor application, the line or tail may be dragged to lengthen or shorten a note Other indicators may also be used, and the examples disclosed herein are not meant to limit the disclosure to any single embodiment. One will appreciate that the process for creating or editing may be completely manual, in which the user selects and edits what notes should be played during the rhythm game. Alternatively or additionally, some aspects of rhythm game data file creation may be automated, such that note selection, rhythm and note type may be automatically discovered by aspects of the rhythm game editor application.

The tempo, beats per minute or “BPM” may also be adjusted in the editor application (block 813 of FIG. 8). A BPM count 911 in FIG. 9 may display the currently calculated BPM for a played music file. The BPM count may be adjusted if it does not exactly match the played music file. Other information may also be displayed in the music editor application, such as the length of the song (913), difficulty level (915) and the like. One will appreciate that the screen shown in FIG. 9 is not meant to be limiting in any fashion.

Once a user is satisfied with the game play for a music file, the rhythm game data file may be saved (block 815 of FIG. 8). In block 817 of FIG. 8, the user may also upload the rhythm game data file to a server so that other users that share the same music may download and install the corresponding rhythm game data file. As discussed above, rhythm game data files do not include playable music files. Instead, the audio content for the rhythm game is provided by the user.

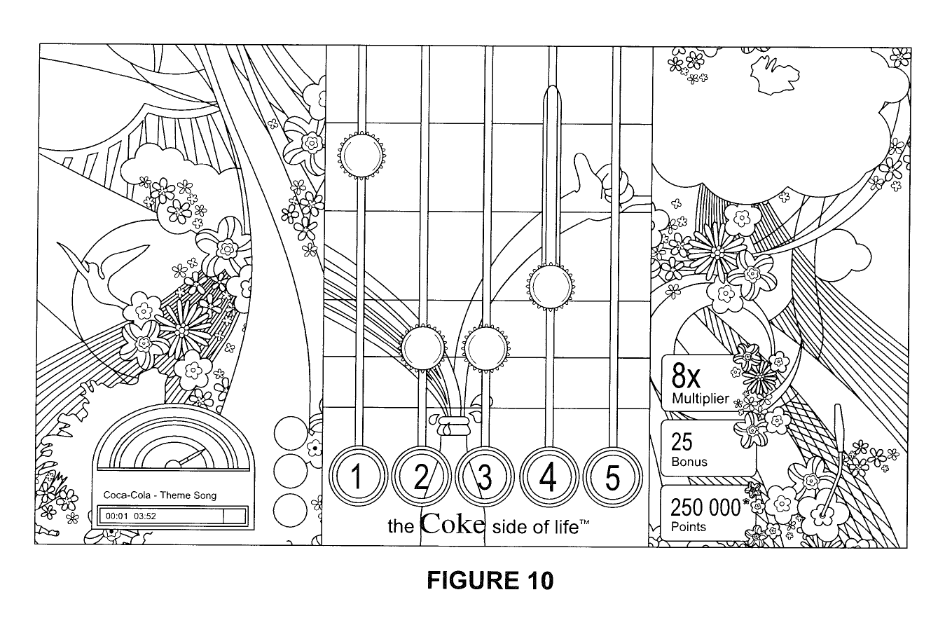

One will appreciate that individual users are not the only possible providers of rhythm game data files. In an embodiment, sponsors, advertisers or other entities may use the rhythm game application and rhythm game editor application to design custom rhythm games for promotional purposes. For example, in FIG. 10, a corporate sponsor can “brand” the rhythm game application with a “skin” or other design in order to provide communicate with users. Movies, album promotions, and other entities may also incorporate aspects of this disclosure to provide a customized rhythm game experience.

A discussed above, an embodiment of this disclosure provides one or users to create, edit and provide rhythm game data files that can be uploaded to server 101 and shared amongst other users. In this fashion, a virtual community or social network is created among music fans and game players. In addition to providing and downloading rhythm game data files, information about users, such as music preferences, high scores and other profile information can be stored and/or accessed by server 101. An embodiment of this disclosure includes integration with existing social networks online, such as Facebook®, MySpace®, hi5™, Bebo®, Twitter®, and the like.

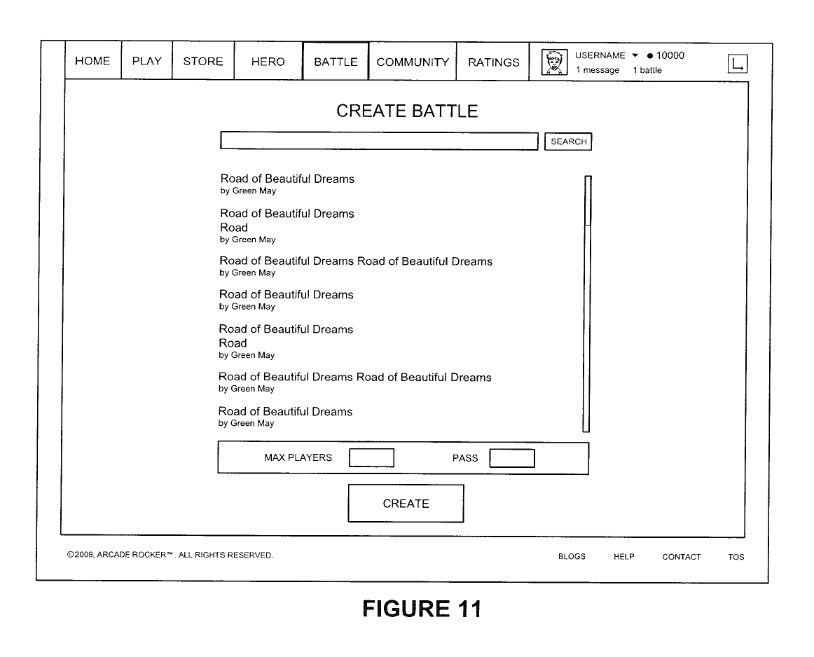

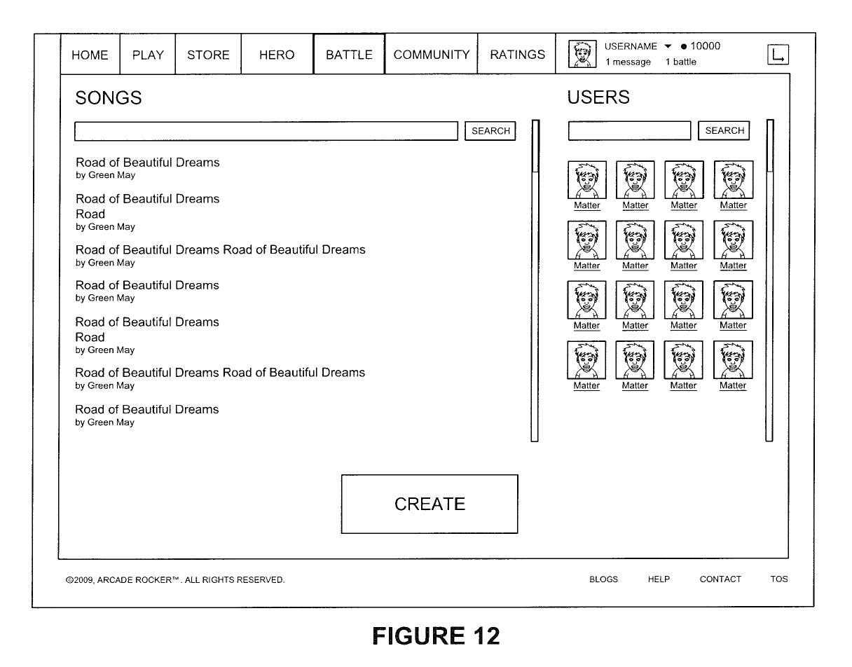

An embodiment of this disclosure includes integration with other features in order to enhance the rhythm game experience amongst groups of users. For example, even though users store music files on their respective computers, if users have common music files, then an embodiment of this disclosure contemplates multi-user game play, such as users playing individual instruments in a “band setting,” or playing against other user in a “battle of the bands” or “battle of the musicians” or “duel” scenario. FIG. 11 is a screenshot of an embodiment where multiple players can participate in a “battle” or “duel.” As shown in FIG. 11, one or more of the battle participants may create a virtual “room” by choosing a rhythm game data file. The users may also set a maximum limit of users who can enter the room. In an embodiment, other users can join the room, which may show availability from an online list displaying available rooms in the multiplayer section of the game. FIG. 12 is a screenshot of an embodiment showing available rooms to a group of potential battle participants that are also online.

When users enter a particular room, they may be asked to load the music file that corresponds to the selected rhythm game data file. Once the music file is loaded for a user, that user's status may show that he is ready to participate in the battle. When all users in the room have loaded the appropriate music file, the room creator may allow the battle to begin. During the rhythm game battle, special bars or other graphic elements may indicate the progress of each user (based on how their current scores). In an embodiment, the user with the highest score is the winner. After the battle has concluded, the users may repeat the rhythm game without “leaving” the room or restarting the rhythm game application.

In an embodiment, two users may participate in a duel. In a duel, both users select a rhythm game data file. In this fashion, each user must not only successfully complete a rhythm game for his chosen song, but for the opponent's song as well.

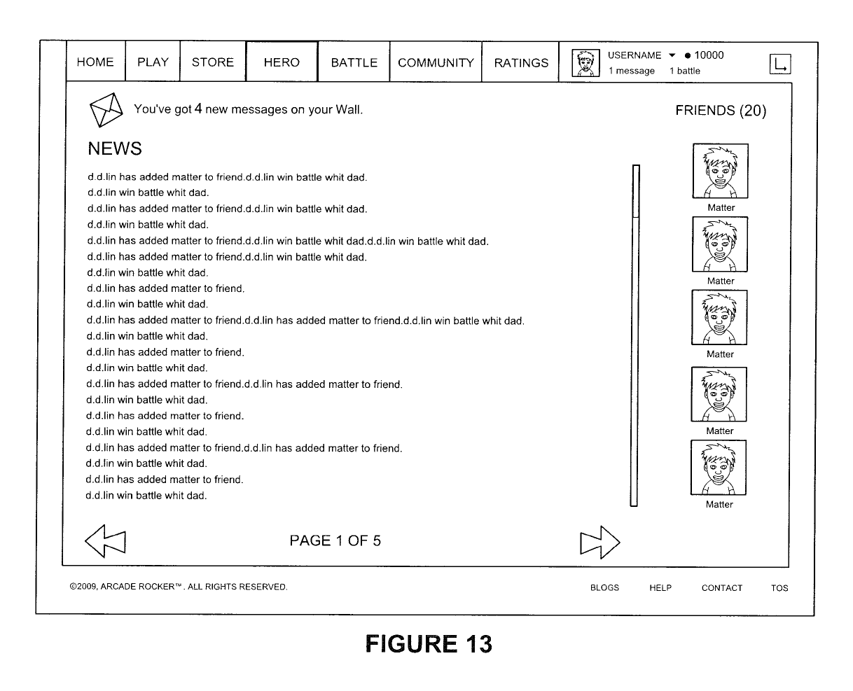

In order to enhance multi-user participation, various features such as instant messaging, wall posts, or other electronic communication methods can be included. Users may send notifications and invitations to other users to join into group game play. FIG. 13 is a screenshot of an embodiment in which a user can view the rhythm gaming activities of other users. One will appreciate that other social networking features may also enhance rhythm game participation, and that FIG. 13 is not meant to be limiting.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of an embodiment. One will appreciate that these steps are merely exemplary and are not meant to be limiting in any way.

Other steps and functions may be contemplated without departing from this disclosure or the scope of an embodiment.

What is claimed is:

1. A method comprising:
providing a server having access to a plurality of rhythm game data files;
providing a rhythm game application for installation on a computer;
receiving, by the server, a request for one of the plurality of rhythm game data files; and,
transmitting the rhythm game data file so that the rhythm game application can synchronously play a music file with the rhythm game data file.

2. The method of claim 1, wherein the music file is stored on the computer.

3. The method of claim 1, wherein the computer is a mobile device.

4. The method of claim 1, wherein the rhythm game application is configured to edit one of the plurality of rhythm game data files.

5. A computer program product, comprising a computer usable medium having a computer readable program code embodied therein, the computer readable program code adapted to be executed to implement a method comprising:
providing a server having access to a plurality of rhythm game data files;
providing a rhythm game application for installation on a computer;
receiving, by the server, a request for one of the plurality of rhythm game data files; and,
transmitting the rhythm game data file so that the rhythm game application can synchronously play a music file with the rhythm game data file.

6. The computer program product of claim 5, wherein the music file is stored on the computer.

7. The computer program product of claim 5, wherein the computer is a mobile device.

8. The computer program product of claim 5, wherein the rhythm game application is configured to edit one of the plurality of rhythm game data files.

9. A system comprising:
a server having memory for storing a plurality of rhythm game data files, wherein each of the plurality of rhythm game data files contains graphic content synchronized to the audio content of a music file.

10. The system of claim 9, wherein the server is configured to transmit at least one of the plurality of rhythm game data files to a computing device executing a rhythm game application, the rhythm game application configured to synchronously play a music file with the at least one of the plurality of rhythm game data files.

11. The system of claim 9, wherein the server is configured to provide a rhythm game, wherein the rhythm game synchronously plays at least one of the plurality of rhythm game data files with a music file resident on a remote computing device.

12. The system of claim 9, wherein the server is configured to receive a rhythm game data file.

13. A method comprising:
receiving, by a server having access to a plurality of rhythm game data files, identifying information for a music file, the music file stored on a remote computing device;
matching, by the server, the identifying information to one of the plurality of rhythm game data files to locate a rhythm game data file that corresponds to the music file; and,
transmitting, by the server, the corresponding rhythm game data file such that the corresponding rhythm game data file is accessible by the remote computing device.

14. The method of claim 13, wherein the identifying information includes a title of a song contained in the music file.
